(19) United States
(12) Patent Application Publication
(10) Pub. No.: US 2003/0218831 A1
(43) Pub. Date: Nov. 27, 2003

(54) Write head for magnetic recording having a corrosion resistant high aspect coil and a method of manufacture

(76) Inventors: Rainer Klaus Krause, Kostheim (DE); Marion Hejny, Mainz (DE); Stefan Seifried, Nidderau (DE); Markus Schmidt, Seibersbach (DE); Manfred Ebert, Mainz (DE)

Correspondence Address: Lewis L. Nunnelley, IBM Corporation, Intellectual Property Law, 5600 Cottle Road (L2PA/0142), San Jose, CA, 95193, US

(21) Appl. No.: 10/153,005

(22) Filed: May 21, 2002

(51) Int. Cl. G11B 5/17

(52) U.S. Cl. 360/123

(57) ABSTRACT

The present invention provides for a write head used in magnetic recording. The write head has at least one coil and the turns in the coil may have a high aspect ratio allowing the head to be used in high density, high data rate applications. Voids in the spaces between turns are avoided by partially removing a photoresist layer before a protective layer overcoat is applied.

### BACKGROUND OF THE INVENTION

1. Field of the Invention

The present invention relates in general to recording heads used in magnetic recording and more specifically to the coil structure used in the write portion of recording heads.

2. Description of the Background Art

Magnetic disk drives are the primary device used to store digital data in a computer system. Disk drives are information storage devices which utilize at least one rotatable disk with generally concentric data tracks, a read/write transducer for reading and writing data on the various tracks, an air bearing slider for holding the transducer adjacent to the disk usually in a flying mode above the disk, a suspension for resiliently holding the air bearing slider and the transducer over the data tracks, and a positioning actuator connected to the suspension for moving the transducer generally radially over the disk surface to the desired data track.

Magnetic recording requires that information is written on a recordable magnetic medium. The process of writing the data is accomplished by using a write head. Generally a write head has a coil partially surrounded by a soft magnetic material such as permalloy. With each new generation of recording devices, typified by disk drives, the write head must be smaller and more efficient to meet the demands for higher recording densities and higher data rates. In particular, to meet the demands for higher data rates the coil along with the rest of the write head must continually decrease in size.

A known method of constructing the coil of a write head includes forming a pattern in a layer of photoresist, for the turns of the coil in the developed photoresist and exposing the photoresist along with the other materials during subsequent planarization. This method has significant complications in designing a planarization equally effective on the photoresist and the other materials present.

Another known method of constructing the coil of a write head includes forming a pattern in a layer of photoresist, forming the turns of the coil in the developed photoresist, removing the photoresist, and filling the space between the turns of the coil with an insulating material which can withstand subsequent planarization. This method is adequate for relatively large write heads. However in order to construct a small write head the coil must be reduced in size. It is preferred to maintain the height and width of the coil turns in order to avoid a significant increase in coil resistance. High resistance can result in heating problems during operation. These heating problems can include protrusion of the write pole tips leading to degraded error rates. By reducing the space between the turns of the coil, the coil resistance can be maintained and the coil is reduced in size.

The aspect ratio of a write head coil is defined as the ratio of the height of a turn in the coil to the distance between the turns of the coil. A relatively large write head might have an aspect ratio of unity, i.e. the height of a turn is equal to the distance between turns. However smaller write heads might have aspect ratios of 3 or 4. Future write heads will require even higher aspect ratios.

One of the most significant problems with high aspect ratio write coils is that if the photoresist is removed to simplify planarization, it is difficult to completely fill the spaces between the turns of the coils with a sputtered insulating material. Voids left between the turns act as sites where corrosion can be initiated. Also voids can leave the structure mechanically weaker.

From the forgoing it will be apparent that there is a need for a write head structure having a coil with a high aspect ratio which has no voids in the spaces between the turns and does not expose photoresist during planarization. There is also a need for a method to realize such a write head.

### SUMMARY OF THE INVENTION

In a preferred embodiment, the invention provides a write coil in which the spaces between turns are completely filled regardless of the aspect ratio of the turns. The invention also provides a structure wherein the photoresist is not exposed during planarization. A write head embodying the invention is robust with respect to corrosion and is mechanically stable.

In one embodiment of the present invention, a portion of the photoresist is removed and a portion of the photoresist is left in the spaces between the turns. A protective overcoat layer is then placed over the remaining photoresist and the turns. This structure minimizes the number of voids between the turns and enhances the structural strength of the coil. This structure is particularly useful when the turns in the coil have a high aspect ratio.

In another embodiment of the present invention a disk drive is described including a write head which has a portion of the photoresist left in the spaces between the turns when the protective overcoat is applied.

In another aspect of the present application a method for partially removing some of the photoresist is disclosed in which reactive ion etching is employed. An alternative method is to expose the photoresist along with partial development. Another alternative method is to use a photoresist with a high dark development rate along with an underexposure.

The embodiments of the present invention mentioned above have several advantages including: minimization of voids in the spaces between the turns; simplification of the planarization process; minimization of opportunities for corrosion of the turns; and, improvements in mask alignment visibility. These and other advantages of the present invention will become apparent from the following detailed description which when taken in conjunction with the accompanying figures illustrate by way of example the principles of the invention.

### BRIEF DESCRIPTION OF THE DRAWINGS

FIGS. 1a through 1q show the general sequence of constructing a portion of the write head according to the prior art;

FIG. 1a shows a layer of alumina and a copper seed layer with a first layer of photoresist;

FIG. 1b shows the patterned photoresist;

FIG. 1c shows the structure after deposition of the turns of the coil;

FIG. 1d shows the structure after removal of the first layer of photoresist;

FIG. 1e illustrates the use of ion etching to remove the copper seed layer;

FIG. 1f shows the second layer of photoresist;

FIG. 1g shows the second layer of photoresist after patterning;

FIG. 1h shows the second layer of photoresist after an optional hard bake;

FIG. 1i shows the structure after the application of a nickel iron seed layer;

FIG. 1j shows the structure after the third layer of photoresist has been added;

FIG. 1k shows the patterning in the third layer of photoresist;

FIG. 1l shows the structure after deposition of additional pole pieces;

FIG. 1m shows the structure after removal of the third layer of photoresist;

FIG. 1n shows the use of an ion etch to remove the nickel iron seed layer;

FIG. 1o shows the structure after the deposition of a protective overcoat layer;

FIG. 1p shows the structure after planarization;

FIGS. 2a through 2c shows an alternate method of avoiding voids;

FIG. 2a shows the structure after the removal of the photoresist;

FIG. 2b shows the structure after the deposition of the protective overcoat;

FIG. 2c shows the structure after planarization;

FIGS. 3a through 3d illustrates the shortcomings of the prior art method when used with a coil with high aspect ratio;

FIG. 3a shows a cross section of two turns before the protective overcoat is applied;

FIG. 3b shows a cross section of the two turns at the beginning of the overcoat deposition;

FIG. 3c shows a cross section of the two turns at an intermediate point during the overcoat deposition;

FIG. 3d shows the completed structure having a deleterious void;

FIG. 4a through 4e shows an example of a structure provided by the present invention;

FIG. 4a shows the structure after the removal of the nickel iron seed layer;

FIG. 4b shows the structure after an additional application of photoresist;

FIG. 4c shows the use of an oxygen reactive ion etch to remove a portion of the photoresist;

FIG. 4d shows the application of a protective overcoat;

FIG. 4e shows the structure after planarization;

FIG. 5 shows a cross sectional view of a completed recording head according to the present invention;

FIG. 6 shows a view of a recording head as attached to a slider; and,

FIG. 7 shows a view of a disk drive.

### DETAILED DESCRIPTION OF THE INVENTION

In one embodiment of the present invention the coil of the write head is constructed such as to have no voids between turns. In another embodiment of the present invention, the surface to be planarized is improved by limiting the number of materials exposed during the chemical-mechanical polish (CMP) planarization. Using prior methods to construct write heads with high aspect ratios results in voids between turns which can initiate local corrosion and also weaken the mechanical strength.

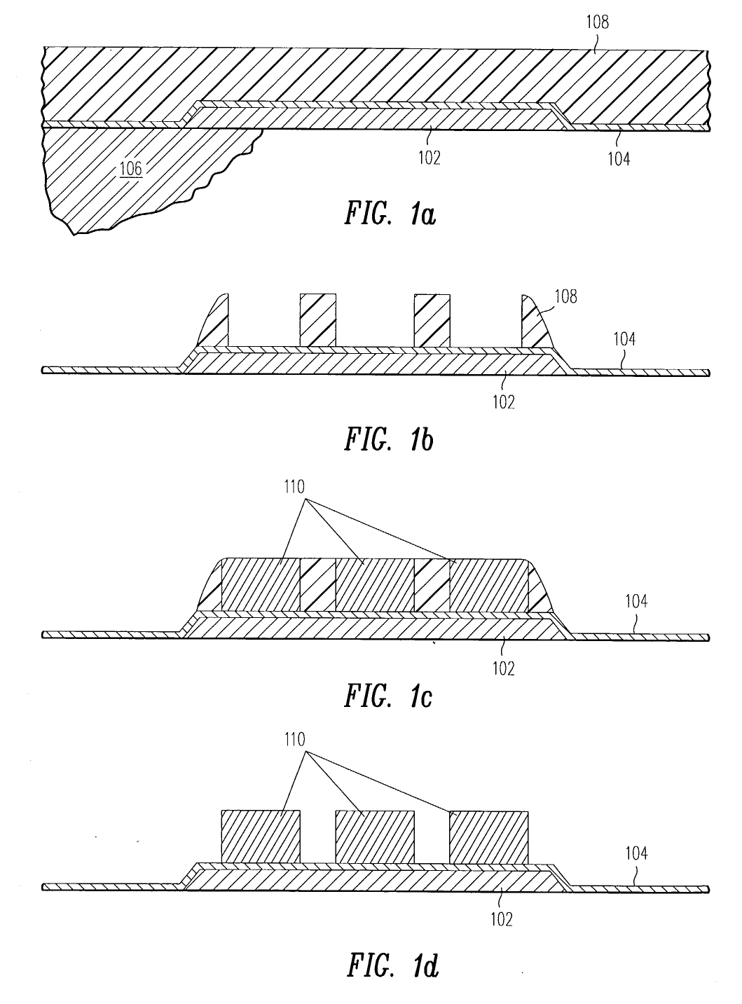

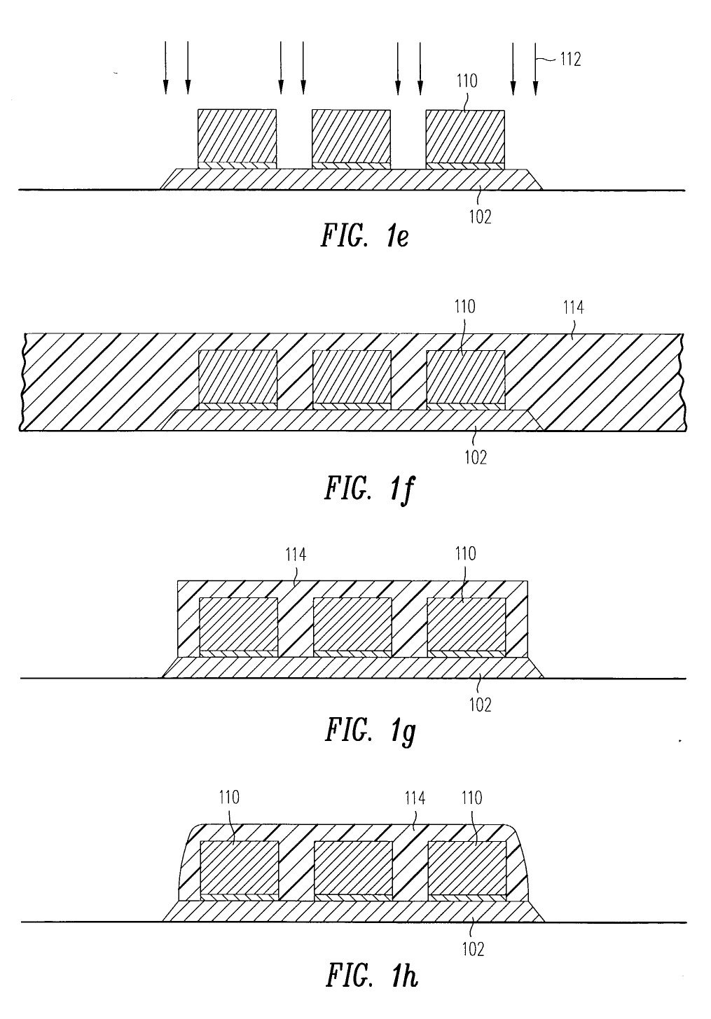

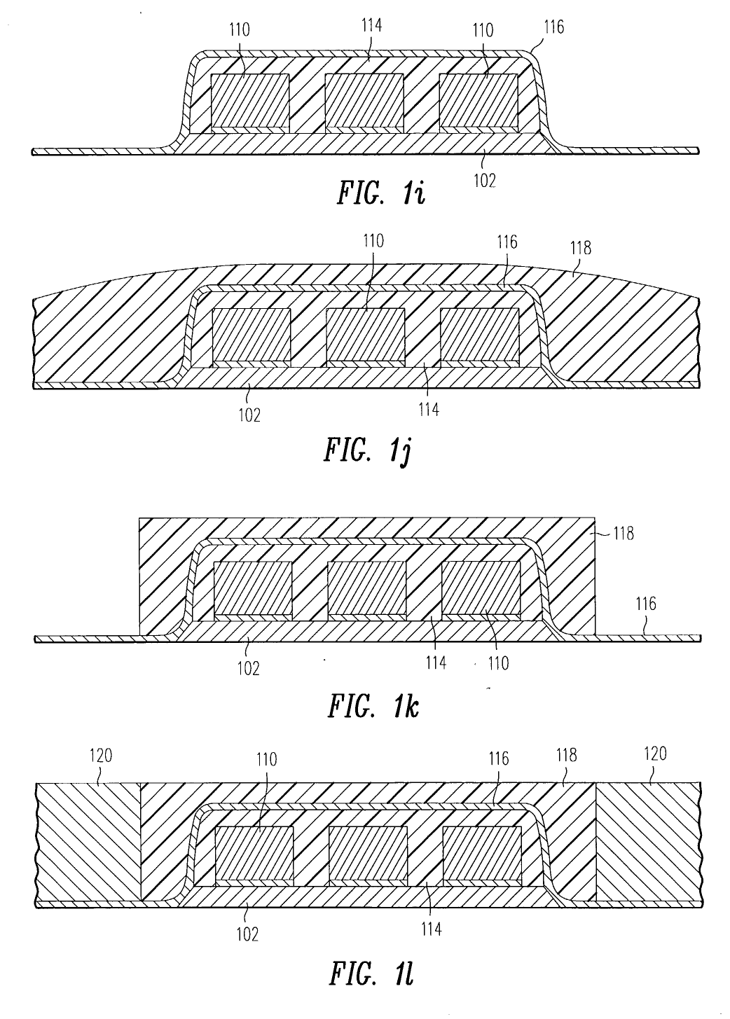

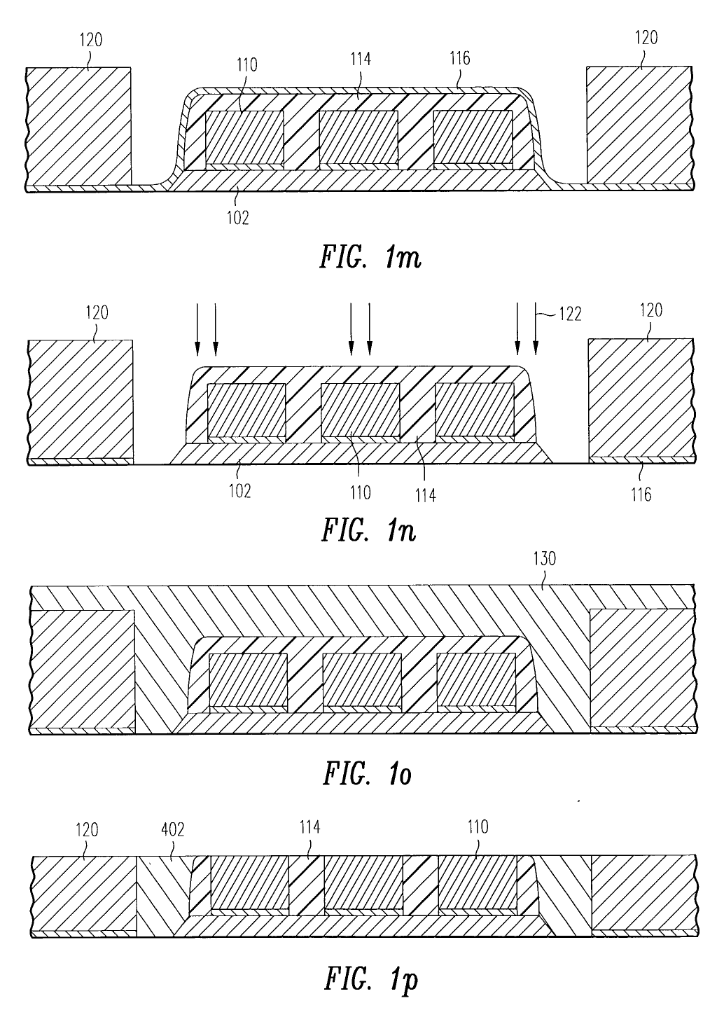

FIGS. 1a through 1q show one example of a sequence of cross sectional views of the structure a prior art method. The prior art is discussed here in detail in order to clearly show the distinction of the present invention. FIG. 1a shows a layer 102 of insulating material such as alumina deposited on a substrate 106. The substrate 106 in FIG. 1a is typically a portion of the bottom pole of the write head. A copper seed layer 104 has been deposited over the alumina 102 and substrate 106 and a layer of photoresist 108 has been deposited over the copper seed layer 104. FIG. 1b shows the photoresist 108 after patterning and development. Patterning and development refers to exposing the photoresist to light through a mask and then subsequently removing portions of the photoresist to form the desired features. FIG. 1c shows the structure after the deposition of the copper coils 110. FIG. 1d shows the structure after the removal of the remaining photoresist with an appropriate solvent. FIG. 1e indicates that the portion of the seed layer 104 which is not directly underneath the copper coils 110 is removed by sputter etching 112. The presence of the copper seed layer is necessary for the electrodeposition of the copper coils. However it is necessary to remove the seed layer to prevent electrical shorting between the turns of the coil. FIG. 1f shows the structure as covered with a second layer of photoresist 114. FIG. 1g shows the second layer of photoresist 114 after patterning. FIG. 1h shows the structure after an optional hard bake of the photoresist 114. FIG. 1i shows the results of depositing a seed layer 116 of an alloy of nickel and iron. The presence of the nickel-iron seed layer 116 is necessary for the electrodeposition of subsequent additional pole members. FIG. 1j shows a third layer of photoresist 118. FIG. 1k shows the third layer of photoresist 118 after patterning. FIG. 11 shows the results of depositing portions 120 of soft magnetic material such as an alloy of nickel and iron. In FIG. 1m the third layer 118 of photoresist has been removed. In FIG. 1n the nickel iron seed layer 116 is removed with a second sputter etch 122.

As illustrated in FIG. 1o, a protective overcoat layer 130 of alumina is deposited directly on the exposed photoresist 114. This resulting structure is then planarized with a chemical-mechanical polish (CMP) planarization as shown in FIG. 1p. Ideally, after planarization the pole members, coil turns, intervening insulating material, and photoresist share a surface in a common plane shown with the reference letter “P” in FIG. 1q. The structure in FIG. 1p has a disadvantage in that four different materials (NiFe alloy 120, alumina 130, copper 110, photoresist 114) are exposed to the CMP. The exposed photoresist is an organic polymer which is not compatible with the other materials during the chemical-mechanical polish. Accordingly, achieving a planar surface where the surfaces of each of the dissimilar materials are not offset because of hardness or chemical incompatibility is difficult.

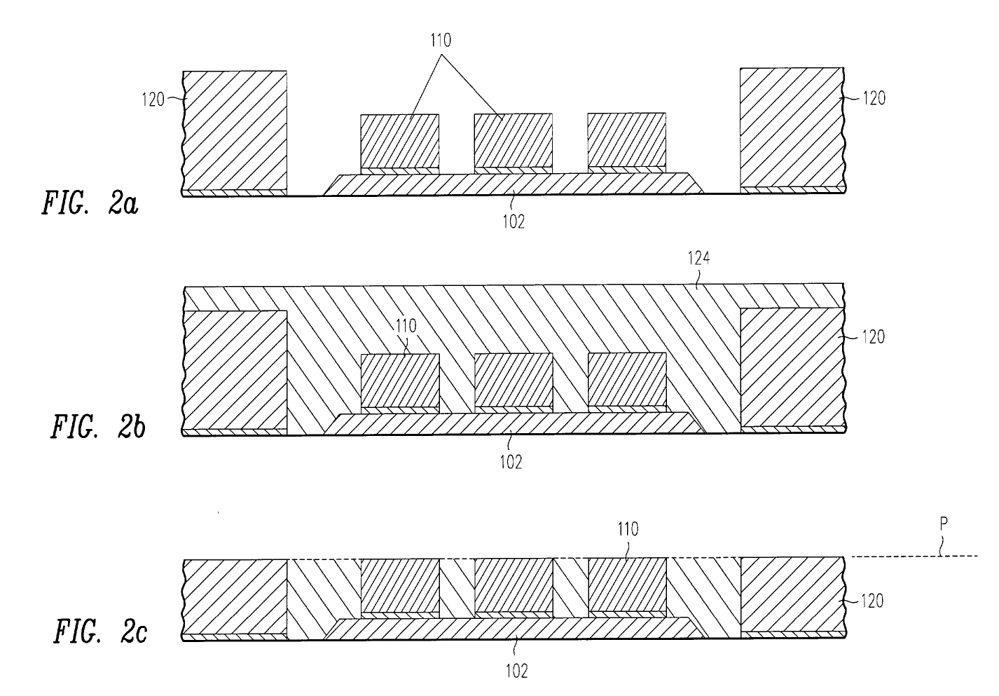

Another method is shown in FIGS. 2a, 2b, and 2c. The sequence of processing illustrated in FIGS. 1a through 1n for this second method is the same as described above. In this alternate method, beginning with the structure shown in FIG. 1n, the photoresist is removed and the result is shown in FIG. 2a. FIG. 2b shows the structure as covered with an insulator such as alumina. FIG. 2c shows the structure after CMP planarization. The structure shown in FIG. 2c has the advantage that the CMP planarization is simplified because the photoresist is not exposed at the planarization surface.

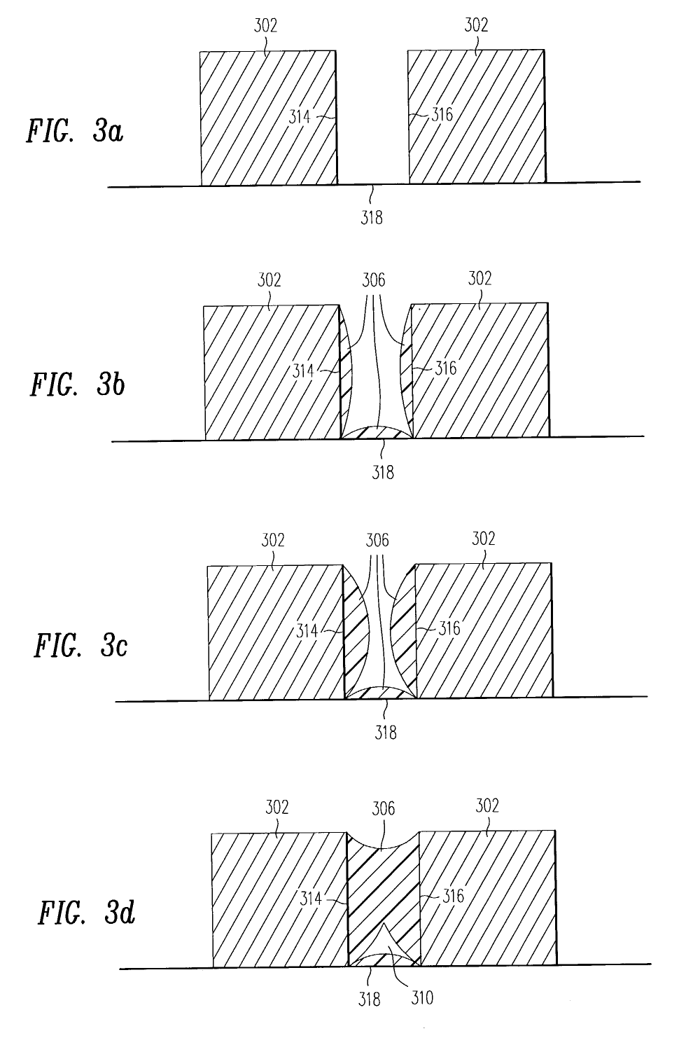

However the structure in FIG. 2c has a disadvantage which is illustrated in FIGS. 3a, 3b, 3c and 3d. FIG. 3a shows a simplified view of the structure as previously shown in FIG. 2a. FIG. 3a shows a cross sectional view of two turns 302 of a coil after the removal of photoresist and before the sputter deposition of the protective overcoat. FIG. 3b shows the protective overcoat 306 at the beginning of the deposition. FIG. 3c shows the accumulation of protection overcoat material 306 is preferentially toward the middle of the surfaces 314, 316, 318 being coated. FIG. 2d shows that a void 310 has been created in the region between turns 302. This void 310 has not been filled with the protective overcoat material 306. This void 310 can generate corrosion by trapping or accumulating undesirable gas. Also any gas trapped in the voids can expand, causing mechanical stress and sometimes mechanical failure of the structure. These shortcomings are particularly noticeable when using this method on a coil having a higher aspect ratio. The aspect ratio of the coils depicted in FIGS. 3a, 3b, 3c, and 3d is approximately 2.0. For higher aspect ratios of 3, 4 or higher values, there may be little protective overcoat material which fills the spaces between the turns of the coil.

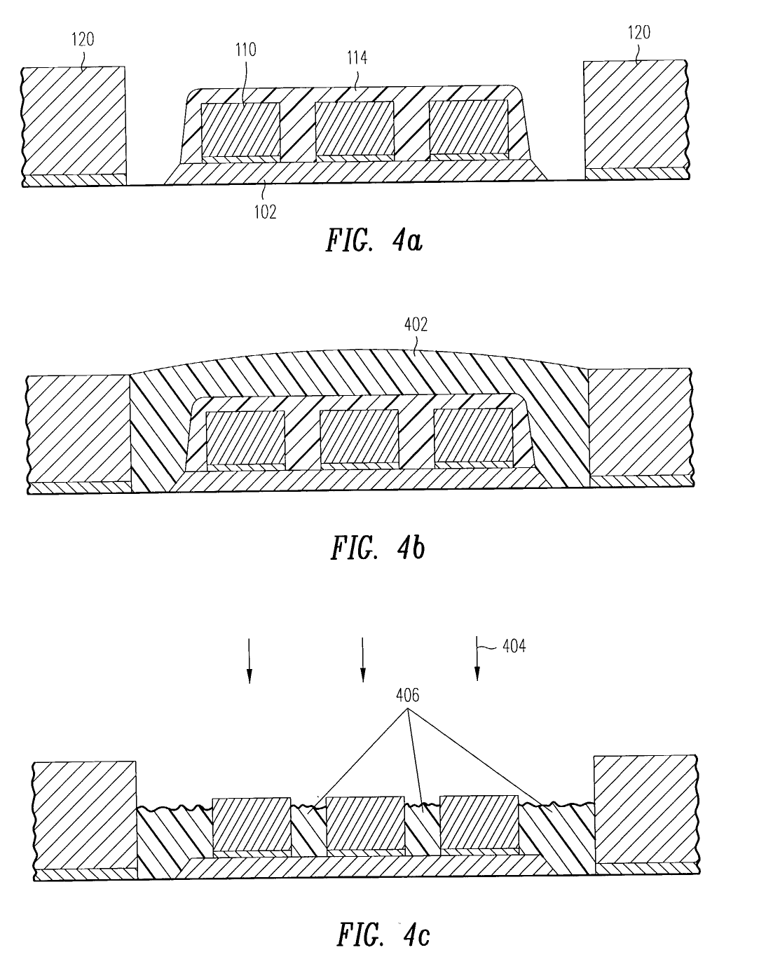

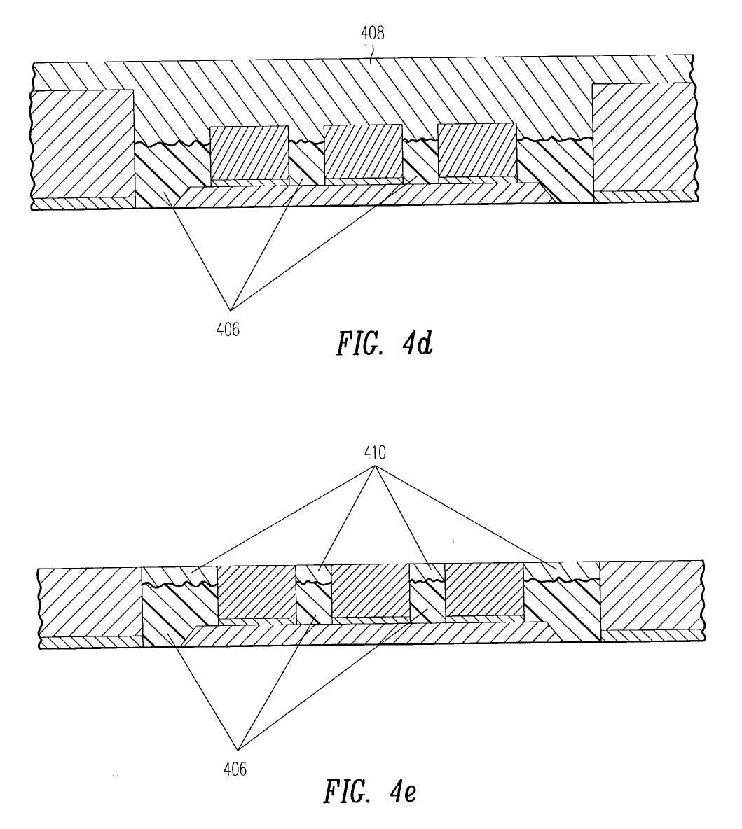

FIGS. 4a, 4b, 4c, 4d, and 4e illustrate one embodiment of the present invention. The structure in FIG. 4a is the result of the sputter etch 122 treatment previously shown in FIG. 1n. In FIG. 4b illustrates the addition of optional but useful additional photoresist 402 to insure the complete filling of any remaining voids. Since photoresist is applied as a liquid, the ability to completely fill the volume between the turns of the coil is much better compared with attempting to fill the same volume by sputter depositing alumina.

FIG. 4c illustrates the use of an oxygen reactive ion etch (RIE) 404 to remove a portion of the total photoresist and also to leave a portion of the total photoresist in place 406. The amount of photoresist material which is removed is controlled by the amount of time in the oxygen RIE. An alternative method is to use a flood exposure of the structure in FIG. 4c. A flood exposure is an illumination of the photoresist without using a mask. After the flood exposure, a development method is used wherein the time in the developer is carefully controlled to remove the desired amount of photoresist. Alternatively a photoresist may be chosen that has a high dark development rate. In this case a lower intensity flood exposure can additionally be used to control the amount of photoresist which is removed.

As illustrated in FIG. 4d, the remaining photoresist 406 along with the rest of the structure is now covered with a protective overcoat 408, typically of alumina. After deposition of the protective overcoat 408 a CMP planarization is performed resulting in the structure shown in FIG. 4e. After planarization the remaining photoresist 406 is covered by the remaining protective overcoat 410 and is not exposed during CMP. CMP is considerably simplified because the number of materials exposed during CMP is reduced. A step height difference can be generated between two dissimilar materials exposed during CMP. This is especially true of exposed photoresist relative to the copper turns or the nickel iron alloy. One significant advantage of the present invention is that photoresist is not exposed during CMP.

An embodiment of the invention, an example of which is illustrated in FIG. 4e, has an important advantage because voids in the spaces between the turns of the coil are largely nonexistent. Accordingly, the corrosion resistance and mechanical strength of the structure is significantly improved. This improvement is particularly advantageous for coils with aspect ratios greater than two.

The materials used in the present invention are known in the art. Typically the lower and upper poles are constructed from a soft magnetic material such as permalloy (NiFe), or other alloys of nickel, iron, and cobalt. The thin insulating layer and the layer which forms the write gap is typically made of alumina or other suitable insulating, nonmagnetic material. The turns of the coil is most commonly made of copper. The protective overcoat can be made of a suitable, corrosion resistant material which is compatible with the CMP used for planarization such as alumina, silicon dioxide, silicon nitride, or aluminum nitride. Several suitable photoresist materials are well known.

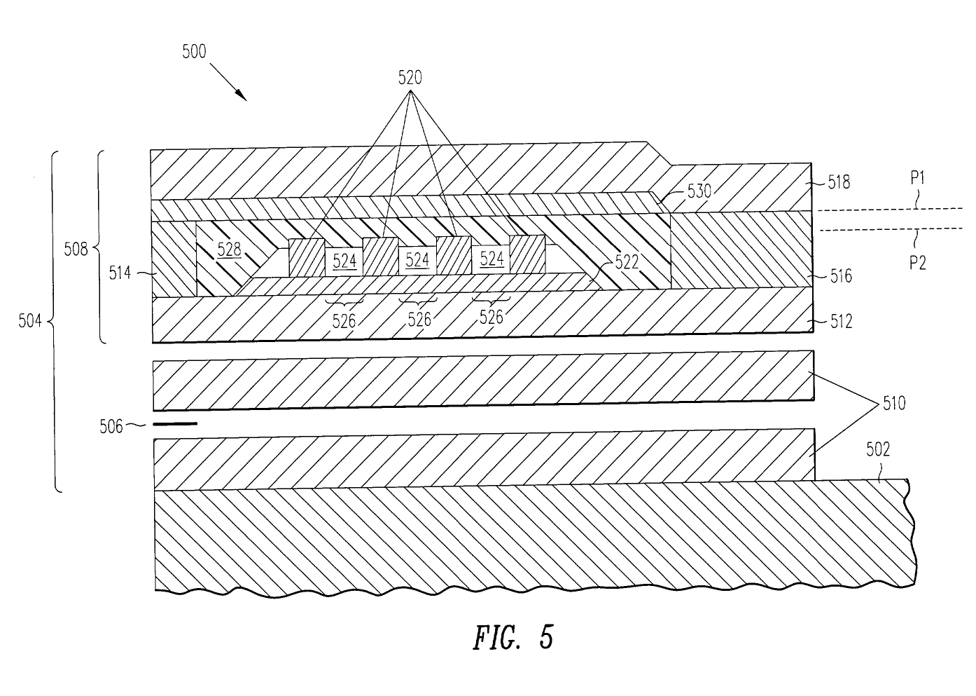

FIG. 5 shows a cross sectional view of an example of a completed recording head 500 according to the present invention. The recording head 504 is constructed on a slider substrate 502. Typically the slider substrate 502, which also forms the slider, is made of a rigid ceramic material such as a composite of titanium carbide and alumina. There may be an insulating layer (not shown), typically of alumina, which separates the substrate 502 from the recording head 504. Generally the read sensor 506 and the write head 508 are separate devices, however in some applications the inductive write head is also used for reading. Usually the read sensor 506 is a thin film sandwich based on the magnetoresistive effect (MR), the giant magnetoresistive effect (GMR), or a tunnel junction effect. The read sensor 506 is disposed between two magnetic shield 510.

Referring again to FIG. 5, the exemplary write head 508 has a lower pole 514, 512, 516 and an upper pole 518. The lower pole shown in FIG. 5 includes a bottom layer 512 of soft magnetic material and two blocks 514, 516 of soft magnetic material placed on the bottom layer 512. The turns 520 of the coil are placed on a thin insulating layer 522. In the spaces 526 between the turns 520 the photoresist 524 has been partially removed. A protective overcoat 528 has been placed over the turns 520 of the coil and the remaining photoresist 524. Typically, during the manufacture of the head a CMP planarization is performed. The result of this planarization can be a plane surface above the coils indicated by “P1” in FIG. 5. Alternatively the plane can include the coils as indicated by “P2” in FIG. 5. To complete the write head 508, the gap layer 530 is deposited and then the upper write pole 518 is deposited.

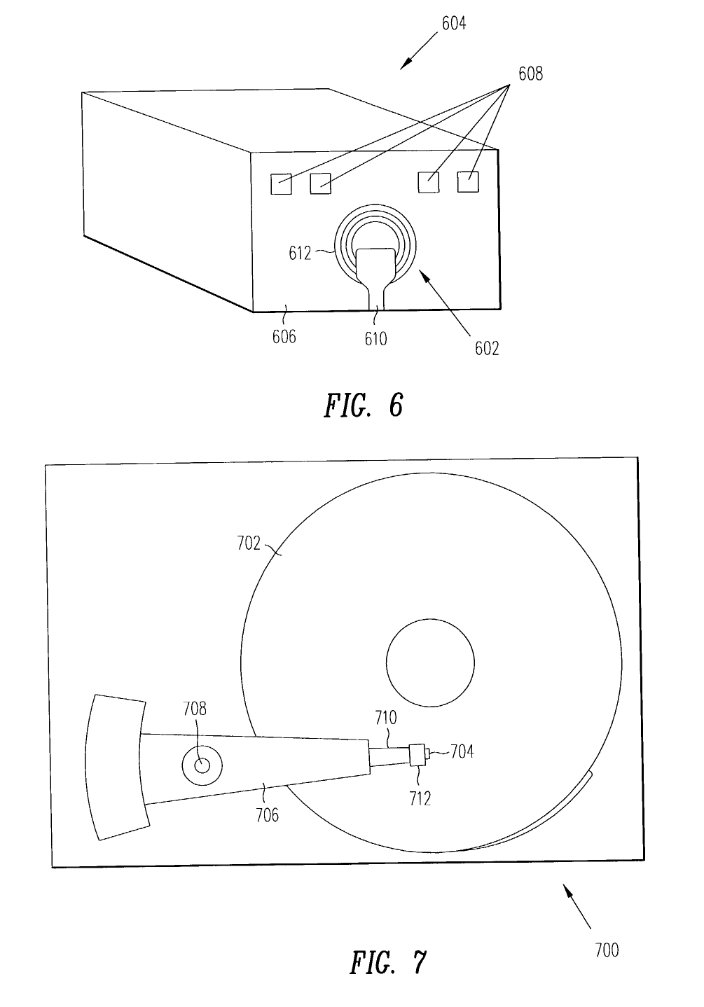

FIG. 6 shows a view of a recording head 602 and slider 604. The recording head 602 is typically constructed on the trailing surface of a slider 604. The trailing surface 606 of the slider 604 has connection pads 608 to make electrical contact with the read element and write head. The write head typically has a soft magnetic yoke 610 disposed around a coil 612.

FIG. 7 shows a drawing of a typical disk drive 700 used for storage of digital information in a computer system. The disk drive 700 is an integrated device which has at least one disk 702 for information storage and at least one recording head 704. The recording head 704 typically has a write head for writing data to the disk and a separate read element for reading information from the disk. The slider 712 to which the recording head 704 is connected is attached to a suspension 710. The suspension 710 is attached to an actuator 706 which can rotate about a pivot 708 thus positioning the recording head 704 at a desired location over the disk 702.

The present invention is not limited by the number of turns in the coil of the write head. Also in the examples shown the coil has one layer of turns. However it is possible to have two or more layers of turns.

From the foregoing it will be appreciated that the present invention provides for a write head which has no void space and in which the photoresist is not exposed during a CMP planarization. Avoiding voids using the present invention is especially advantageous for high aspect ratio coils. By only partially removing the photoresist the risk of void induced corrosion is greatly reduced.

We claim:

1. A write head for magnetic recording, comprising:
at least one coil including turns and spaces between said turns,
said spaces between turns being partially filled with photoresist, said photoresist having a protective overcoat.

2. A write head as in claim 1 wherein said protective overcoat is formed from alumina, silicon dioxide, silicon nitride, or aluminum nitride.

3. A write head as in claim 1 wherein said turns have an aspect ratio greater than two.

4. A disk drive, comprising:
at least one disk; and,
a recording head, said recording head including a write head, said write head comprising
at least one coil including turns and spaces between said turns,
said spaces between turns being partially filled with photoresist, said photoresist having a protective overcoat.

5. A disk drive as in claim 4 wherein said protective layer overcoat is formed from alumina, silicon dioxide, silicon nitride, or aluminum nitride.

6. A disk drive as in claim 4 wherein said turns have an aspect ratio greater than two.

7. A method of manufacturing a write head for magnetic recording having a coil with turns and photoresist in the spaces between the turns, comprising:
removing a portion of said photoresist from the spaces between the turns;
forming a protective overcoat over the turns and remaining photoresist.

8. A method as in claim 7 wherein said protective overcoat is formed from alumina, silicon dioxide, silicon nitride, or aluminum nitride.

9. A method as in claim 7 wherein said turns have an aspect ratio greater than two.
